(19) United States
(12) Patent Application Publication
(10) Pub. No.: US 2003/0149718 A1
(43) Pub. Date: Aug. 7, 2003

(54) Method for transmitting voice information via an internet protocol

(76) Inventor: Thomas Theimer, Baierbrunn (DE)

Correspondence Address: MORRISON & FOERSTER LLP, 1650 TYSONS BOULEVARD, SUITE 300, MCLEAN, VA, 22102, US

(21) Appl. No.: 10/276,097

(22) PCT Filed: May 22, 2001
(86) PCT No.: PCT/DE01/01976

(30) Foreign Application Priority Data
Jun. 7, 2000 (DE) 100 28 143.5

(51) Int. Cl. G06F 15/16

(52) U.S. Cl. 709/201

(57) ABSTRACT

The invention relates to a method for transmitting voice information via an internet protocol. Said information is exchanged in packets between at least two nodes via a link layer protocol (PPP) by compressing the headers of the packets. A connection-oriented transmission protocol (MPLS) allows to establish a unidirectional tunnel between the at least two nodes. The inventive method is further characterized in that one forward tunnel and one reverse tunnel is established between the two nodes, that both tunnels are combined to give a bidirectional link, thereby facilitating a bidirectional communication, and that packets the packets of the link layer protocol (PPP) are guided via one respective tunnel.

The invention relates to a method pursuant to the preamble of claim 1.

As part of the convergence of voice networks and data networks, the transmission of voice over IP networks (Voice over IP, VoIP) is gaining greater and greater significance. Protocols such as TCP/IP or UDP/IP, for example, have taken shape as Internet protocols. In the case of the TCP protocol, a security process takes place; i.e., if a packet is lost, it is requested and transmitted again. In the UDP protocol, on the other hand, this security process is absent.

For this reason, in the state of the art, voice transmission is controlled using a real-time protocol such as the RTP real-time protocol, for example, via UDP/IP. The packets carrying the voice data are generally relatively small (working part approximately 40-80 bytes). In addition, a header precedes the working part of the packet carrying the working data; this header also has a size of approximately 40 bytes. In the final analysis, this means that in an extreme case, a voice packet to be transmitted has a working part of 40 bytes, preceded by a header of approximately the same size. The packet therefore has an overhead of 100%, so that the bandwidth efficiency of such a solution must be considered very low.

In the IETF, there are various concepts for improving this bandwidth efficiency in VoIP. These are generally based on compression of the headers. In this connection, there are basically two known methods; namely, link-based methods and tunnel-based methods:

In the case of link-based methods, the entire RTP header is reduced to a size of 2-4 bytes. The method is called link-based because the method is used only for transmission between two directly adjacent nodes. Implementation takes place using PPP as the link-layer protocol. However, this method has the disadvantage that the very complicated compression has to be carried out in every node along a VoIP connection between two subscribers. This results in a high level of complexity and high cost, and is very difficult to implement at high bit rates.

In the case of tunnel-based methods, the compression takes place end to end at the input/output nodes of the tunnel. In this method, a tunnel is first established between two nodes and later the voice information is transmitted via this tunnel. The establishment of the tunnel takes place by means of a signaling packet sent at the beginning of the transmission, or administratively. Since the voice data is transmitted in the tunnel, it is invisible to the intermediate nodes.

A simple method for header compression was already proposed for MPLS (Multi Protocol Label Switching). However, for VoIP, this method achieves only a reduction of the header to approximately half of the original 40 bytes. The efficiency of the transmission process is therefore not particularly high.

Another known method uses the known L2TP protocol as the tunnel protocol, which is used to implement both PPP multiplexing and RTP header compression end-end. This proposed solution has the advantage that it is compatible with the standardized RTP header compression. In addition, several voice packets can be combined to make a larger packet. It is also a problem, in this connection, that only a reduction in the size of the header to approximately half of the original 40 bytes can be achieved. Furthermore, here again the quality of service is not particularly high, since no resources can be reserved, for example (connection-free protocol). The present invention is based on the task of indicating a way in which more efficient transmission of voice data over IP networks can be achieved.

The invention is advantageous in that the MPLS tunnel mechanism is used in place of the known L2TP tunnel mechanism. This results in better efficiency. According to the invention, RTP compression and PPP multiplexing are carried out within an MPLS tunnel.

This results in greater efficiency, in that only the MPLS header (4 bytes) and the PPP header (1-2 bytes) have to be transmitted, instead of 36 bytes for the combined IP/UDP/L2TP header. Furthermore, a guaranteed bandwidth and quality of service are present here. This is due to the fact that MPLS tunnels are connection-oriented and therefore allow both guaranteed bandwidths (through explicit reservation) and fewer delay variations. These requirements can be signaled when the tunnel is being established.

Another advantage of the invention is that no sequence errors occur. Thus, it can be assured, by selecting the parameters appropriately, that the packet sequence within the tunnel is maintained. This eliminates the need for reconstruction of the original packet sequence, as is required in L2TP.

Furthermore, the procedure according to the invention brings with it a high level of reliability. For example, in case of an error, an MPLS tunnel equipped with MPLS protection switching can be reversed or restored very quickly. In contrast to this, L2TP depends on the convergence of the IP routing protocols, so that node or line failures can result in interruptions of several tens of seconds.

Finally, a particular advantage of the invention can be seen in the controlled path selection, in that the path of an MPLS tunnel in the network can be influenced directly by the network operator. Using MPLS Explicit Routing, individual nodes or groups of nodes along the path can be defined in this way. In this manner, the voice traffic can be controlled in a targeted manner by the network, for example to circumvent slow or unreliable lines.

Advantageous further developments of the invention are indicated in the dependent claims.

The invention is explained in greater detail below, on the basis of an exemplary embodiment shown in drawings. These show:

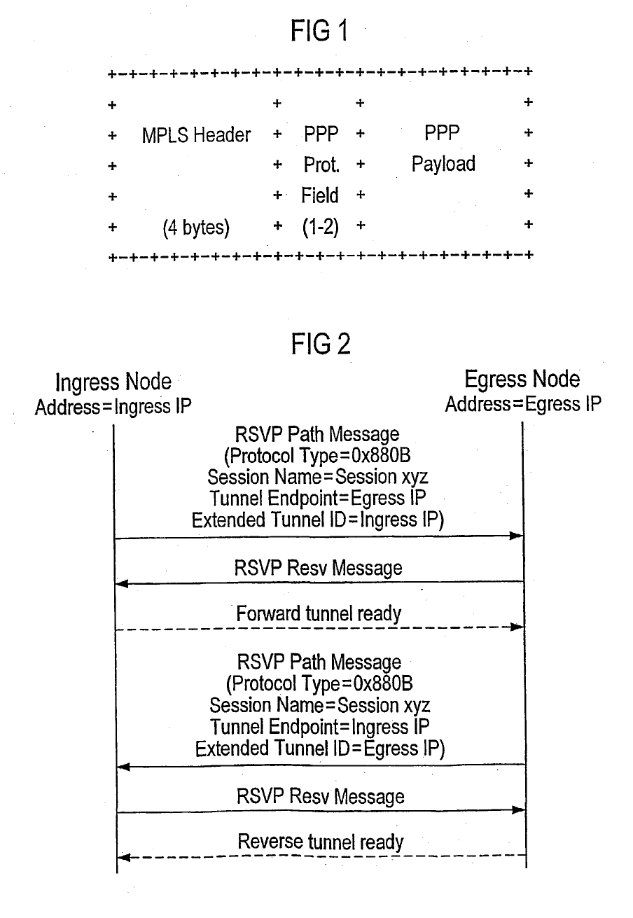

FIG. 1 A packet format that can be used for the transmission of PPP in MPLS;

FIG. 2 The algorithm according to the invention.

FIG. 1 shows a packet format, as an example, that can be used for the transmission of PPP in MPLS. Accordingly, the PPP protocol field directly follows the MPLS header. The PPP working data can contain several compressed RTP packets, for example. This results in a minimal overhead of 4 bytes per voice packet, plus MPLS and PPP headers of 5 or 6 bytes. At 10 voice packets of 40 bytes each in an MPLS packet, this results in a bandwidth efficiency of 400/446, or roughly 90%.

In the following, the individual steps for establishing a tunnel are described in FIG. 2, using the example of TE-RSVP as the signaling protocol:

In a first step, the establishment of a unidirectional MPLS tunnel is first initiated from one side. The establishment of the tunnel takes place using the TE-RSVP signaling protocol. This protocol contains a Label Request Object, which among other things defines the protocol to be transmitted. Here, the value 0x880B must be indicated for PPP.

The Session Attribute Object of the TE-RSVP signaling protocol contains a session name that in principle can be freely selected. However, the session name must clearly identify the tunnel for the input node and the output node. The session name, together with the IP addresses of the input node and the output node, must therefore be unambiguous.

Furthermore, the LSP Tunnel Session Object must contain the IP address of the input node as an Extended Tunnel ID. This address is used later for addressing, when the tunnel is established in the reverse direction.

Finally, a bandwidth is generally reserved for the tunnel, and special delay requirements can be signaled.

Once this information is provided, the tunnel is established in the forward direction. In a second step, the tunnel is now established in the reverse direction. The node at the tunnel output (seen in the forward direction) recognizes that bidirectional communication is necessary, based on the PPP protocol type, and in turn initiates establishment of the tunnel in the reverse direction. Both the protocol type and the session name must agree absolutely with the forward direction. This, together with the IP addresses of the end points, makes it possible to combine the two tunnels in a bidirectional link. The IP address of the input node, which was established when the tunnel was created in the forward direction, is used as the target address.

As soon as both tunnels have been successfully established, and have been combined to form a bidirectional link, configuration of the link by means of the PPP protocol can take place in a third step. Starting from this point, the control passes over to the PPP protocol and from this time on the MPLS tunnel is viewed merely as a point-to-point link-layer connection. The PPP protocol can now establish the use of RTP compression and PPP multiplexing, provided this is supported by the two end points of the tunnel. In this connection, the MPLS tunnel appears as a point-point link from the point of view of PPP. PPP packets are transmitted as a payload in MPLS packets.

1. Method for transmitting voice data over an Internet protocol,
where data is exchanged in packets between at least two nodes via a Link Layer Protocol (PPP), in that the headers of the packets are compressed, and with a connection-oriented transmission protocol (MPLS), which can be used to establish a tunnel between the at least two nodes, in a unidirectional manner,
characterized in that
a tunnel is established between the two nodes, in the forward direction and the reverse direction, in each instance,
that subsequently both tunnels are combined to form a bidirectional connection, making bidirectional communication possible, and
that the packets of the Link Layer Protocol (PPP) are conducted via one tunnel, in each instance.

2. The method according to claim 1, characterized in that the tunnel is established using a signaling protocol (TE-RSVP, CR-LDP).

3. The method according to claim 1, 2, characterized in that when the tunnel is established in the forward direction, data is signaled that allows automatic establishment of the tunnel in the reverse direction, by the opposite side.

4. The method according to one of the preceding claims, characterized in that the packets of the Link Layer Protocol (PPP) are also transmitted with compressed headers, if necessary.

5. The method according to one of the preceding claims, characterized in that compression of the headers takes place using the method of RTP header compression.

6. The method according to one of the preceding claims, characterized in that several working packets are transmitted in a PPP packet, using PPP multiplexing.

7. The method according to one of the preceding claims, characterized in that the connection-oriented transmission protocol is the MPLS protocol.
